(19) United States
(12) Patent Application Publication
(10) Pub. No.: US 2014/0306527 A1
(43) Pub. Date: Oct. 16, 2014

(54) METHOD FOR PROVIDING CONTROL POWER WITH AN ENERGY GENERATOR AND AN ENERGY CONSUMER

(71) Applicants: Georg Markowz, Alzenau (DE); Wolfgang Schweissthal, Mandelbachtal (DE); Carsten Kolligs, Bottrop (DE); Anna Flemming, Frankfurt (DE); Dennis Gamrad, Voerde (DE); Sebastien Cochet, Oberhausen (DE)

(72) Inventors: Georg Markowz, Alzenau (DE); Wolfgang Schweissthal, Mandelbachtal (DE); Carsten Kolligs, Bottrop (DE); Anna Flemming, Frankfurt (DE); Dennis Gamrad, Voerde (DE); Sebastien Cochet, Oberhausen (DE)

(73) Assignees: Evonik Industries AG, Essen (DE); Evonik Degussa GmbH, Essen (DE); STEAG Power Saar GmbH, Saarbruecken (DE)

(21) Appl. No.: 14/357,263

(22) PCT Filed: Oct. 26, 2012
(86) PCT No.: PCT/EP2012/071235

§ 371 Date: May 9, 2014

(30) Foreign Application Priority Data
Nov. 10, 2011 (DE) 10 2011 055 227.8

(51) Int. Cl. H02J 3/24

(52) U.S. Cl. CPC H02J 3/24
USPC 307/24; 307/127

(57) ABSTRACT

A method and device for a provision of control power for a power supply network in which control power is provided, wherein an energy producer and an energy consumer are jointly operated, wherein the power which the energy consumer removes from the power supply network is restricted to provide a positive control power, and the power which the energy producer feeds into the power supply network is restricted to provide a negative control power.

The present invention relates to a method for the provision of control power for a power supply network in which control power is provided, and a device to carry out a method of this type.

Power supply networks are used to distribute power in large areas among many users and to supply households and industry with energy. Energy producers, mainly in the form of power stations, provide the necessary energy for this purpose. The power production is normally scheduled and provided on the basis of forecast consumption.

However, unscheduled fluctuations can arise in both the production and consumption of energy. These may arise on the energy producer side because, for example, a power station or part of the power supply network fails or, for example, in the case of renewable energies such as wind, because the energy production turns out to be higher than forecast. Unexpectedly high or low consumptions can arise in respect of the consumers also. The failure of a part of the power supply network, for example, which cuts some consumers off from the energy supply, can result in a sudden reduction in the power consumption.

Generally, the result of this is that fluctuations in the network frequency occur in power supply networks due to unscheduled and/or short-term deviations in power production and/or consumption. The required alternating current frequency is, for example, 50,000 Hz in Europe. This frequency is also often referred to as the nominal frequency. A reduction in the consumption compared with the schedule results in an increase in the frequency in the case of scheduled produced power by the energy producers, and the same applies to an increase in the power production compared with the schedule in the case of scheduled consumption. Conversely, a reduction in the power of the energy producers compared with the schedule results in a reduction in the network frequency in the case of scheduled consumption, and the same applies to an increase in the consumption compared with the schedule in the case of scheduled production.

For reasons of network stability, it is necessary for these deviations to be kept within a defined framework. To do this, targeted, positive control power must be provided, depending on the level and direction of the deviation, through connection of additional producers, such as, for example, power stations, and/or disconnection of consumers or negative control power through disconnection of producers and/or connection of consumers. The need generally exists for an economical and efficient provision of these control powers, wherein the requirements for the capacities to be retained and the dynamics of the control power sources may vary according to the characteristic of the power supply network.

In Europe, there is, for example, a code (UCTE Handbook) which describes three different control power categories. The respective requirements for the control power types are also set out therein. The control power types differ, inter alia, in the requirements for the dynamics and the duration of the power provision. Furthermore, they are used differently in terms of the boundary conditions. Primary control power is to be provided independently from the location of the cause of the disruption on a pan-European basis from all incorporated sources, essentially in proportion to the prevailing frequency deviation. The absolute maximum power is to be provided in the case of frequency deviations of minus 200 mHz and (absolutely) thereunder, while the absolute minimum energy is to be provided in the case of frequency deviations of plus 200 mHz and above. In terms of dynamics, the respective maximum energy (in terms of amount) must be provided from the idle state within 30 seconds. Conversely, secondary control power and minute reserve power are to be provided in the balance areas in which the disruption has occurred. Their role is to compensate for the disruption as quickly as possible and thus ensure that the network frequency again lies in the target range as quickly as possible, preferably after 15 minutes at the latest. In terms of dynamics, less stringent requirements are imposed on the secondary control power and the minute reserve power (5 and 15 minutes respectively until full power provision following activation), and at the same time these powers are also to be provided over longer time periods than primary control power.

In currently operated power supply networks, a large part of the control energy is provided by conventional power stations, in particular coal-fired and nuclear power stations. Two fundamental issues arise from this. On the one hand, the conventional power stations providing control power are not operated at full load and therefore at maximum efficiencies, but slightly below the same in order to be able to provide positive control power on demand, if necessary over a theoretically unlimited time period.

For a long-term provision of control power, the necessary control power sources must therefore generally be operated under partial load in order to be able to remove or supply additional energy according to demand. If, for example, a power station is to be used, this would have to be run under partial load in order to be able to provide positive control power also on demand. Similarly, a consumer would have to be run under partial load in order to be able to increase the load if additional negative control power were required.

These partial-load modes of operation are normally disadvantageous. In most conventional power stations (e.g. coal-fired power stations or gas-fired power stations), the partial-load operation results in a lower efficiency of the power production and higher specific emissions. Furthermore, increased specific fixed costs are incurred with reduced use of capacity. In the case of consumers operated under partial load, productivity and also efficiency are reduced. An electrolysis plant which is used for chemical production has a lower productivity corresponding to the load reduction and only a smaller proportion of the consumed energy is converted into the product, i.e. a greater quantity of energy is required for the same product quantity.

It is therefore disadvantageous that these sources are mainly run under partial load for the retention of the control power, and can be operated under full load only if they provide precisely maximum control power, and thus the losses are correspondingly high.

US 2006/122738 A1 discloses an energy management system comprising an energy producer and an energy store, wherein the energy store is chargeable by the energy producer. An energy producer which does not guarantee consistent energy production in normal operation, such as, for example, the increasingly preferred renewable energies, such as wind power or photovoltaic power stations, is thereby intended to be enabled to feed its energy more consistently into the power supply network. The disadvantage here is that, although an individual power station can thus be stabilized, all other disruptions and fluctuations in the power supply network cannot be compensated.

Furthermore, it is known from WO 2010 042 190 A2 and JP 2008 178 215 A for energy stores to be used for the provision of positive and negative control power. If the system frequency leaves a range around the required system frequency, energy is either provided from the energy store or fed into the energy store in order to regulate the system frequency. DE 10 2008 046 747 A1 also proposes to operate an energy store in an isolated power supply network in such a way that the energy store is used to equalize consumption peaks and consumption minima.

In the article entitled “Optimizing a Battery Energy Storage System for Primary Frequency Control” by Oudalov et al., in IEEE Transactions on Power Systems, Vol. 22, No. 3, August 2007, the minimum capacity of a battery is defined, so that said battery can provide control power in accordance with European standards (grid code).

It is known from DE 10 2008 002 839 A1 to operate energy consumers in the form of lifts in such a way that unused lifts of an entire region are run into upper floors to provide negative control power. If negative control power is therefore required, the power of a consumer is increased.

A method is known from DE 10 2009 018 126 A1 for the provision of control power in which a flammable gas is produced with renewable energies and stored. Here, the flammable gas can be reconverted precisely in time periods with high residual load of the power supply network. The power of a gas-fired power plant is therefore increased if a positive control power is required. The disadvantage here is that the gas-fired power station is operated at high power and with high efficiency only in the case of a full control requirement, i.e. in rare cases only.

The disadvantage here is therefore that there is currently no facility to operate energy producers or energy consumers for the provision of control power, where possible, exactly as efficiently as in the operation for the provision of power without control and therefore with optimum efficiency, and also over a lengthy period in order to provide control power for the stabilization of the power supply network. The overdimensioning is in any case uneconomical.

In view of the prior art, the object of the present invention is then to provide a technically improved method for the provision of control power for a power supply network in which control power is provided which is not affected by the disadvantages of conventional methods.

Here, it is intended to be enabled to provide control power by means of energy producers or energy consumers which can be operated under the best possible conditions, quite particularly with the highest possible efficiency. The control power suppliers are thus intended to have the most efficient possible energy yield.

The method according to the invention is furthermore intended to be suitable, where possible, for providing the necessary control power as quickly as possible.

In particular, the energy producers or energy consumers are intended to be able to provide a sufficient quantity of positive or negative control power in a targeted manner, independently from the level and direction of the deviation of the network frequency. The energy producer and energy consumer can thereby be operated as a control power supplier.

Furthermore, it is intended that the method can be carried out as simply and economically as possible.

In addition, it is intended that the method can be carried out with as few method steps as possible, wherein said steps are intended to be simple and reproducible.

Further objects not explicitly named can be inferred from the overall context of the following description, examples and claims.

These objects and further objects which are not explicitly named but can be derived or deduced directly from the context discussed in the introduction above are achieved by a method with all of the features of claim 1. Appropriate variants of the method according to the invention for the provision of control power for a power supply network in which control power is provided are protected in subclaims 2 to 9. Furthermore, the subject-matter of patent claim 10 is a device to carry out a method of this type, while appropriate variants of this device are protected in subclaims 11 and 12.

The subject-matter of the present invention is accordingly a method for the provision of control power for a power supply network in which control power is provided, characterized in that an energy producer and an energy consumer are jointly operated, wherein the power which the energy consumer removes from the power supply network is restricted in order to provide a positive control power and the power which the energy producer feeds into the power supply network is restricted in order to provide a negative control power.

A joint operation of the energy producer and the energy consumer is understood here to mean that both are not operated independently from one another, but are controlled via a common control.

Furthermore, the following advantages, inter alia, can be achieved by means of the method according to the invention:

It is thereby possible in an unforeseeable manner to carry out a method for the provision of control power for a power supply network which is not affected by the disadvantages of conventional methods.

In particular, it is made possible here to provide control power by means of energy producers and energy consumers which are operated primarily under optimum conditions, such as, for example, with high efficiency.

Furthermore, the energy producers and energy consumers have a more efficient energy yield as control power suppliers than conventional energy producers and energy consumers used individually or independently from one another for the provision of control power.

In particular, the energy producers and energy consumers can provide a sufficient quantity of positive or negative control power in a targeted manner, independently from the quantity and the sign of the deviation of the network frequency.

In addition, the method according to the invention can be carried out very simply and economically.

In addition, the method can be carried out with relatively few method steps, wherein said steps are simple and reproducible.

A restriction of an energy producer or an energy consumer is understood according to the invention to mean a reduction in the power which is supplied to or removed from the power supply network. Unlike the known prior art, it is crucial here that, in the case of a requirement for positive control power in the power supply network, the power of the energy producer is not increased, but the power of the energy consumer is reduced. The opposite applies in the case of a requirement for negative control power, wherein the power of the energy consumer is not increased, as known in the prior art, but the power of the energy producer is reduced.

Through this joint operation of an energy producer and an energy consumer, a method for the provision of control power for a power supply network in which control power is provided is made available in a surprising manner which does not comprise the operation of energy producers and/or energy consumers which must be operated in partial-load operation if no control power is required in order to be able to supply the necessary control power in the event of a control power requirement by means of a power increase for a power supply network.

Instead of the conventional, frequent partial-load operation, these energy producers and energy consumers run under partial load only when required—and therefore significantly less frequently overall—and accordingly cause significantly fewer losses due to partial-load operation, such as, for example, a lower power production efficiency, reduced productivity and/or higher specific emissions. Furthermore, increased specific fixed costs are incurred with reduced use of capacity.

It can also be provided according to the invention that a power station, preferably a coal-fired power station, a gas-fired power station or a hydroelectric power station is used as an energy producer, and/or an industrial production plant, in particular an electrolysis plant or an industrial production plant for the provision of a metal, preferably aluminium or steel, is used as an energy consumer.

Within the meaning of the present invention, the energy producers and energy consumers are intended to be devices which are included among the major plants in the industrial sense on the basis of the level of the control power provided.

It can furthermore be provided that a thermal power station, a coal-fired power station, a nuclear power station, an oil-fired power station, a solar thermal power station, a gas-steam power station, a biomass thermal power station, a gas turbine power station, a generating set, a hydroelectric power station, a geothermal power station and/or combined heat and power are used.

It can furthermore be provided that the energy producer and/or the energy consumer has or have a maximum power of at least 1 MW, preferably at least 10 MW, particularly preferably at least 100 MW.

The energy consumers can preferably include the large metallurgical plants for the purification of copper and other metals and also those industrial production plants which have a substantial energy requirement.

It can be provided here that the energy producer and the energy consumer are operated with a relative efficiency in relation to the respective theoretical maximum efficiency of the energy producer or energy consumer of at least 70%, preferably of at least 80%, particularly preferably of at least 90%, quite particularly preferably of at least 95%, if no control power is provided.

It is hereby intended to be made clear that, in this preferred embodiment of the present invention, the energy producer can be further operated with undiminished efficiency in the provision of positive control power, while the positive control power is provided by restricting the power of the energy consumer. The same applies accordingly to the opposite case of the provision of negative control power, wherein the energy consumer is further operated with undiminished efficiency, while the negative control power is provided by means of a power restriction of the energy producing.

In a preferred embodiment, it can furthermore be provided that the energy producer is operated under full load except in the provision of negative control power and/or the energy consumer is operated under full load except in the provision of positive control power.

Surprising advantages are evident in particular in a particularly preferred embodiment of the invention in which an energy store, in particular a battery, preferably a Li-ion battery, or a pool of energy stores is operated jointly with the energy producer and the energy consumer, and the energy store, in particular the battery, is operated in such a way that it is given priority over the energy consumer and the energy producer in the provision of positive and/or negative control power, wherein the energy store, in particular the battery, preferably has a capacity of at least 4 kWh, preferably of at least 10 kWh, particularly preferably at least 50 kWh, quite particularly preferably at least 250 kWh.

The capacity of electrochemical energy stores can be at least 40 Ah, preferably around 100 Ah. If stores are used which are based on electrochemical elements, in particular batteries, this store can advantageously be operated with a voltage of at least 1 V, preferably at least 10 V and particularly preferably at least 100 V.

It can furthermore be provided that a flywheel, a heat store, a hydrogen producer and store with a fuel cell, a natural gas producer with a gas-fired power station, a pumped storage power station, a compressed air storage power station, a superconducting magnetic energy store, a redox flow element and/or a galvanic element is used as an energy store, preferably a battery and/or a battery storage power station, particularly preferably a lithium ion battery. It can also be provided that combinations (“pools”) of energy stores, particularly of energy stores of this type, are used.

The heat store must be operated together with a device for the production of power from the stored heat energy.

The batteries include, in particular, lead batteries, sodium nickel chloride batteries, sodium sulphur batteries, nickel iron batteries, nickel cadmium batteries, nickel metal hydride batteries, nickel hydrogen batteries, nickel zinc batteries, tin sulphur lithium ion batteries, sodium ion batteries and potassium ion batteries.

Batteries which have a high efficiency and a long operational and calendar life are preferred here. As a particularly preferred embodiment of the invention, lithium polymer batteries, lithium titanate batteries, lithium manganese batteries, lithium iron phosphate batteries, lithium iron manganese phosphate batteries, lithium iron yttrium phosphate batteries, lithium air batteries, lithium sulphur batteries and/or tin sulphur lithium ion batteries are used as lithium ion batteries.

The ratio of the rated power of the energy store to the maximum power of the control energy suppliers can preferably be in the range from 1:10000 to 10:1, particularly preferably in the range from 1:1000 to 1:1.

It can also be provided that the energy store has a capacity of at least 4 kWh, preferably of at least 10 kWh, particularly preferably at least 50 kWh, quite particularly preferably at least 250 kWh.

It can furthermore be particularly advantageous if, in the event of the additional use of an energy store, in particular a battery, both the capacity and/or the energy storage capability of the energy store, in particular the battery, is adapted to the maximum power and/or the maximum change with time in the power of the energy consumer and/or the energy producer.

In this respect, it may be advantageous that the energy store, in particular the battery, is used to prevent overshoots over the rated power and/or to accelerate the change with time in the power in the event of a change in the control power to be provided.

It can furthermore be provided that the prequalified power of the energy producer corresponds to the prequalified power of the energy consumer.

It can be provided here that the power of the energy producer deliverable to the power supply network and/or the power of the energy consumer removable from the power supply network can be changed within 15 minutes, preferably within 5 minutes, particularly preferably within 30 seconds, by at least 70%, preferably by at least 85%, particularly preferably by at least 95%, in particular together with a battery.

In a preferred embodiment, a direct current consumer such as, for example an electrolysis, is used as a restrictable consumer. In this case, a battery can advantageously be incorporated into the intermediate direct current voltage circuit of the consumer so that the outlay for the power electronics can be eliminated or reduced.

The present invention furthermore provides a preferred device to carry out the method according to the invention. A device according to the invention comprises at least one energy producer, at least one energy consumer and a control to control or regulate the power of the energy producers and energy consumers, wherein the energy producers and energy consumers are connected to a power supply network in such a way that energy can be fed into the power supply network and can be removed from the power supply network by means of the device.

A control is understood here according to the invention to mean a simple control. It should be noted here that every regulation comprises a control, since, in the case of a regulation, a control is effected depending on a difference between an actual value and a target value. The control is therefore preferably designed as a regulation, particularly in relation to the state of charge. The control is particularly preferably a control system.

In a preferred embodiment of this device, it can furthermore be provided that the control is designed so that the energy producer and/or the energy consumer are operable at any time with a high efficiency in relation to the respective theoretical maximum efficiency of the energy producer or energy consumer, in particular with an efficiency of at least 70%, preferably at least 80%, particularly preferably of at least 90%, quite particularly preferably of at least 95%.

It may furthermore be preferable that the device comprises an energy store, in particular a battery, which is connected to the power supply network in such a way that energy can be fed from the energy store, in particular from the battery, into the power supply network, and can be removed from the power supply network.

The invention is based on the surprising realization that it is possible, through the joint operation of an energy producer and an energy consumer and through the reduction of the produced power for the provision of negative control power and the reduction of consumed power for the provision of positive control power, to operate both the energy producer and the energy consumer mainly with high efficiencies and therefore significantly more productively than has hitherto been the case. Assuming that control power has to be provided in any case during only 50% of the time, the energy producer and the energy consumer can also be operated during 50% of the time, i.e. twice as long as hitherto, with a high, preferably with a maximum, efficiency. Productivity is thereby increased.

Particularly in the area of primary control power provision, battery stores or batteries are increasingly proposed as alternatives to conventional energy producers and energy consumers. Battery stores and batteries generally have the following disadvantages:
Due to the losses in the input and output of energy into/from storage, a draining of the battery charge occurs sooner or later in the case of a statistically symmetrical deviation of the network frequencies from the target value through operation. It is therefore necessary to charge the store more or less regularly in a targeted manner. This charge current may have to be paid for separately.
Consistent compliance with the guidelines for the prequalification of primary control technologies requires the retention of corresponding power reserves at any given operating time and thus for every state of charge of the store. As a result of this requirement (in Germany currently: the marketed primary control power over a duration of 15 min), a corresponding investment-cost-increasing capacity of the energy store must be retained. This reserve would in fact only be used very infrequently (for statistical reasons).
The analysis of real frequency characteristics shows that considerable energy quantities are repetitively fed in or out. For a given storage capacity, this results in a correspondingly substantial change in the state of charge. Substantial changes in the state of charge in turn tend to result in faster ageing than minor changes in the state of charge. Either the energy store thus reaches the end of its life sooner and must be replaced sooner, or the capacity must be increased a priori in order to reduce the relative change in the state of charge. Both result in an increase in investment costs.

In the case of batteries as energy stores, the state of charge corresponds to the state of charge (SoC) or the state of energy (SoE).

For these reasons, the operation of a pool of dynamic energy stores, in particular batteries and conventional sources for the provision of control power, which can provide greater positive and/or negative control powers, also comes into consideration according to the invention. If, for example, a power station is to be used in combination with a battery, it would have to be run under partial load in order to be able to provide positive control power also on demand. However, this is no longer necessary according to the invention.

According to the invention, batteries can now also be used in combination with energy producers and energy consumers, wherein the aforementioned disadvantages are overcome.

In preferred embodiments of the invention, a plurality of energy stores are pooled and operated using a method according to the invention. The size of the energy stores within the pool may vary. In a particularly preferred embodiment, in the case of the various energy stores of a pool and with the use of tolerances, in particular the selection of the bandwidth in the deadband, the switch from one parameter setting to another is not carried out synchronously, but in a targeted, deferred manner in order to minimize or at least keep tolerable any disruptions in the network.

The tolerance in relation to the amount of the control power provided and the tolerance in the determination of the frequency deviation, etc. is to be understood according to the invention to mean that certain deviations between an ideal target power and the actually provided control power are accepted by the network operator on the basis of technical boundary conditions such as the measurement accuracy in determining the control power provided or the network frequency. The tolerance may be allowed by the network operator, but could also correspond to a legal requirement.

In a further preferred embodiment, the tolerances used in the various methods, in particular the selection of the bandwidth in the deadband, vary depending on the time of day, the day of the week and/or the time of year. For example, the tolerances may be more narrowly defined in a time period from 5 min before to 5 min after the hour change. This is justified in that very rapid frequency changes often occur here. It may be in the interest of the transmission network operators that smaller tolerances occur here and therefore the control energy is provided more reliably in the sense of a sharper focus.

According to a further embodiment, it can be provided in connection with the specifications for the provision of control power that, in particular, more energy is removed from the network than is fed into the network by the energy store. This can occur because, according to the regulations, including the method described above, a very large quantity of negative control power is preferably provided, whereas, according to the regulations, including the method described above, only the at least assured power in terms of positive control power is preferably provided. On average at least 0.1% more energy is preferably removed from the network than is fed in, in particular at least 0.2%, preferably at least 0.5%, particularly preferably at least 1.0%, specifically preferably 5%, wherein these values are related to an average which is measured over a time period of at least 15 minutes, preferably at least 4 hours, particularly preferably at least 24 hours, and specifically preferably at least 7 days, and related to the energy fed in.

The control power provision described above can be used here to remove a maximum of energy from the network, wherein the maximum possible negative control power is provided, whereas only a minimum positive control power is provided.

In the embodiments for the preferred and specifically for the maximum energy consumption, the energies thereby removed from the network can be sold via the previously described energy trading, wherein this preferably takes place at times when the highest possible price can be achieved. Price development forecasts based on historical data can be used for this purpose.

Furthermore, the state of charge of the energy store at the time of a planned energy sale may preferably be at least 70%, particularly preferably at least 80% and particularly preferably at least 90% of the storage capacity, wherein the state of charge following the sale is preferably at most 80%, in particular at most 70%, and particularly preferably at most 60% of the storage capacity.

Preferred embodiments of the present invention are explained below by way of example with reference to nine figures, but without restricting the invention. In the drawings:

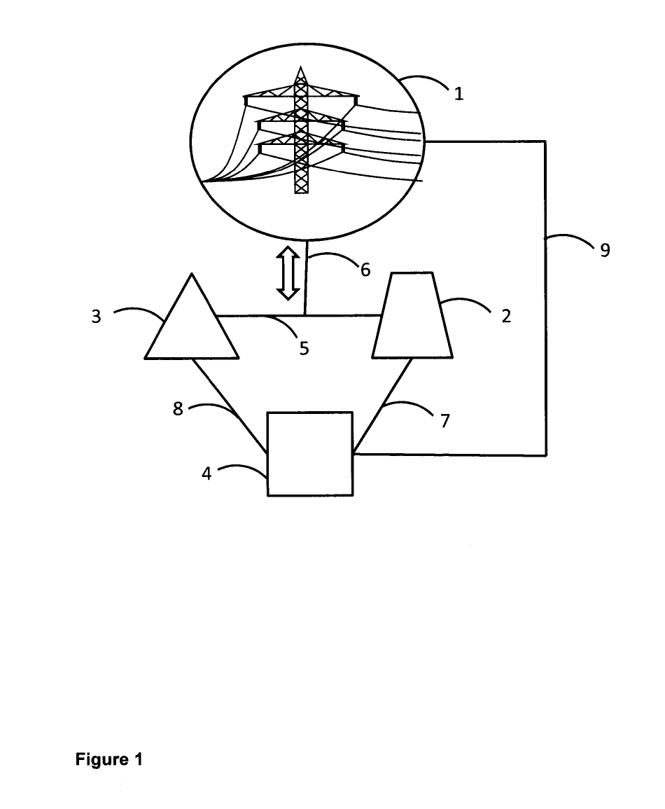

FIG. 1: shows a schematic set-up of a device according to the invention;

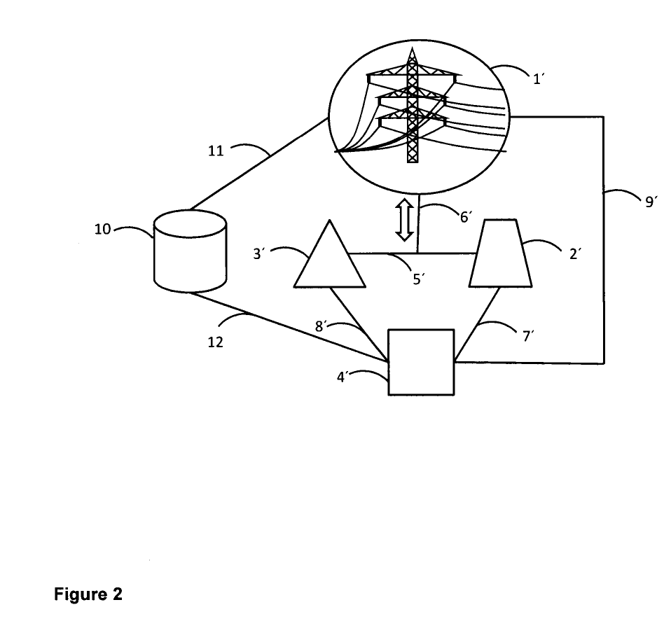

FIG. 2: shows a schematic set-up of a further preferred embodiment of a device according to the invention;

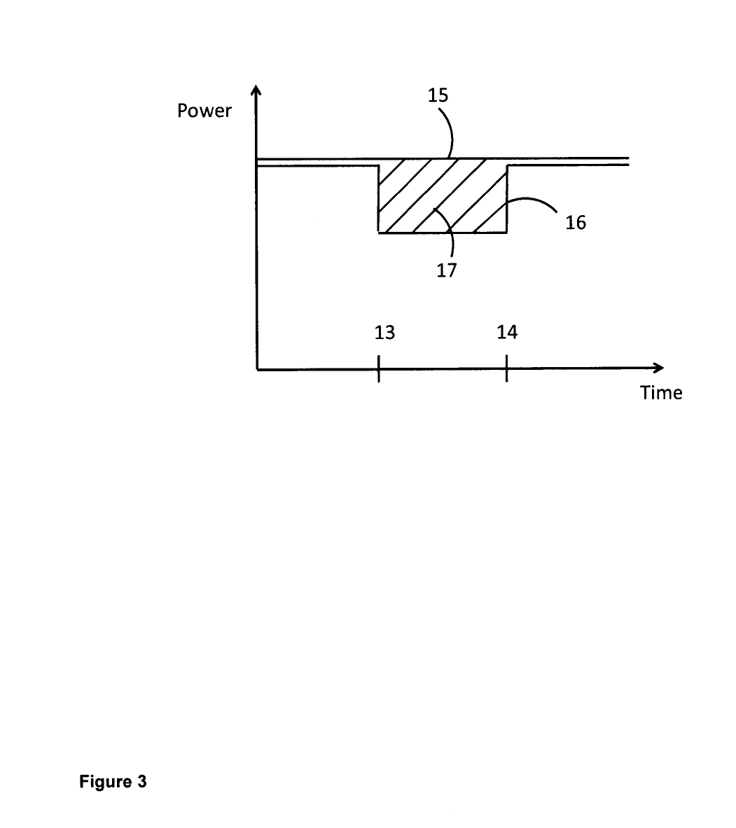

FIG. 3: shows a schematic power/time diagram for a positive control power request;

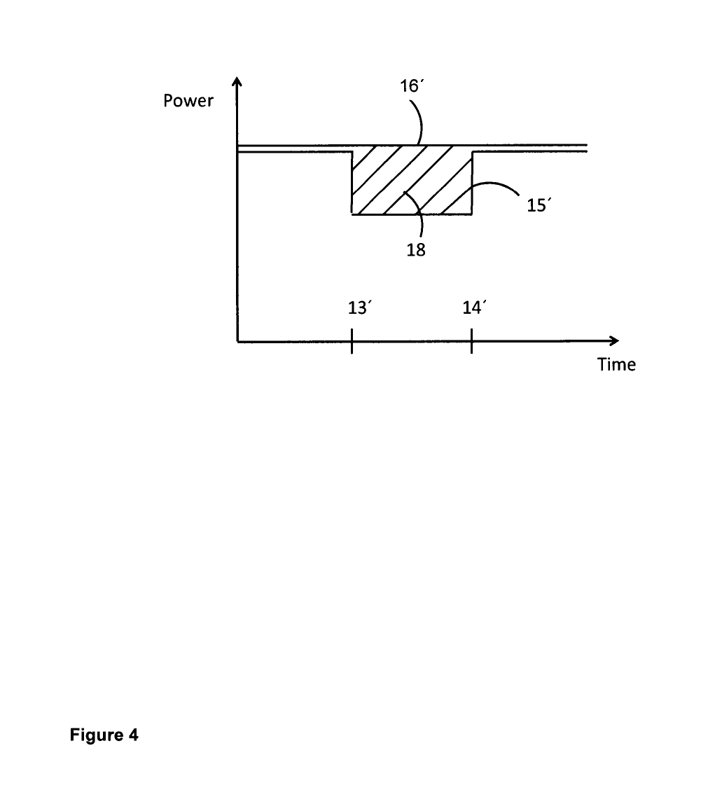

FIG. 4: shows a schematic power/time diagram for a negative control power request;

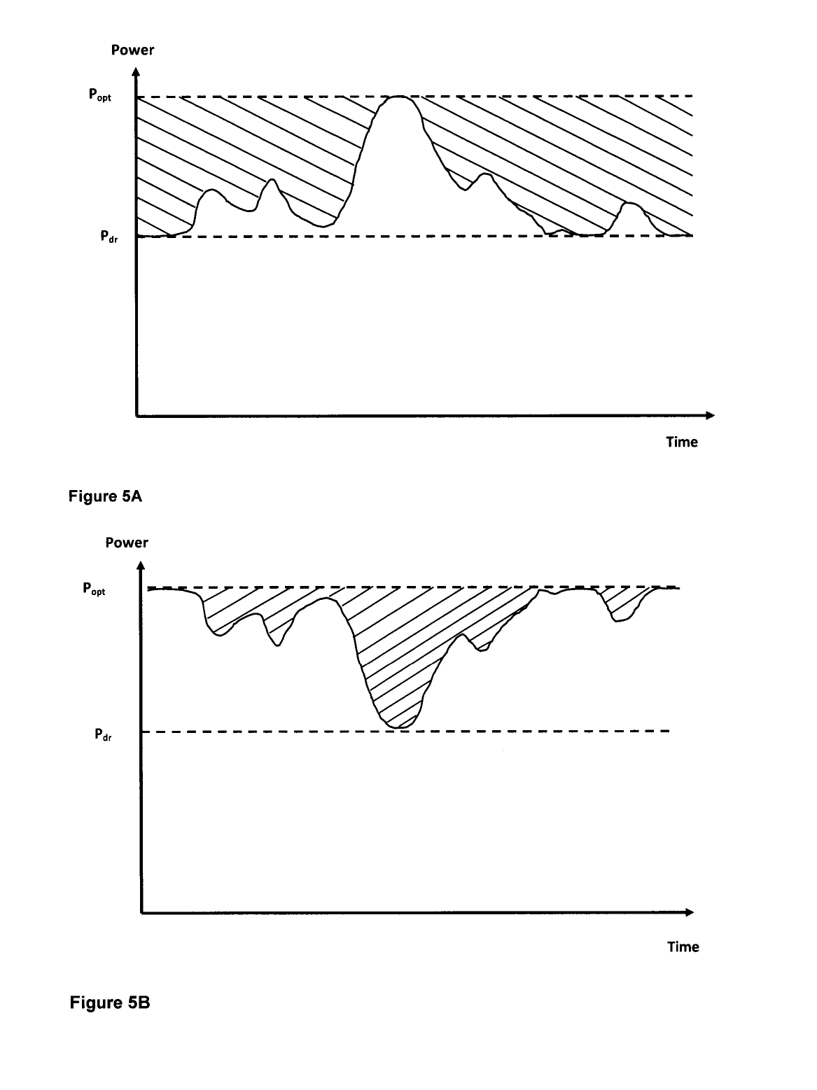

FIGS. 5A and B: show further schematic power/time diagrams to illustrate the invention;

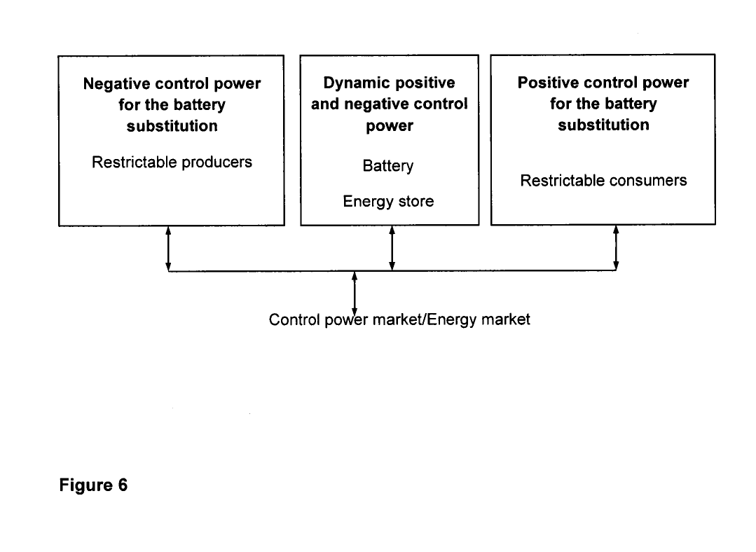

FIG. 6: shows a schematic representation of a device according to the invention with restrictable energy producers and consumers incorporating an energy store;

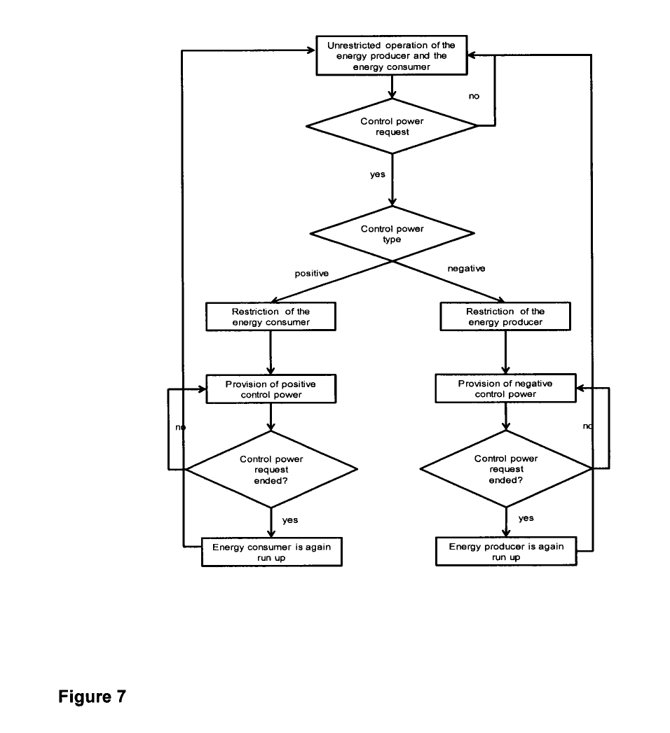

FIG. 7: shows a schematic flow diagram of a method according to the invention; and

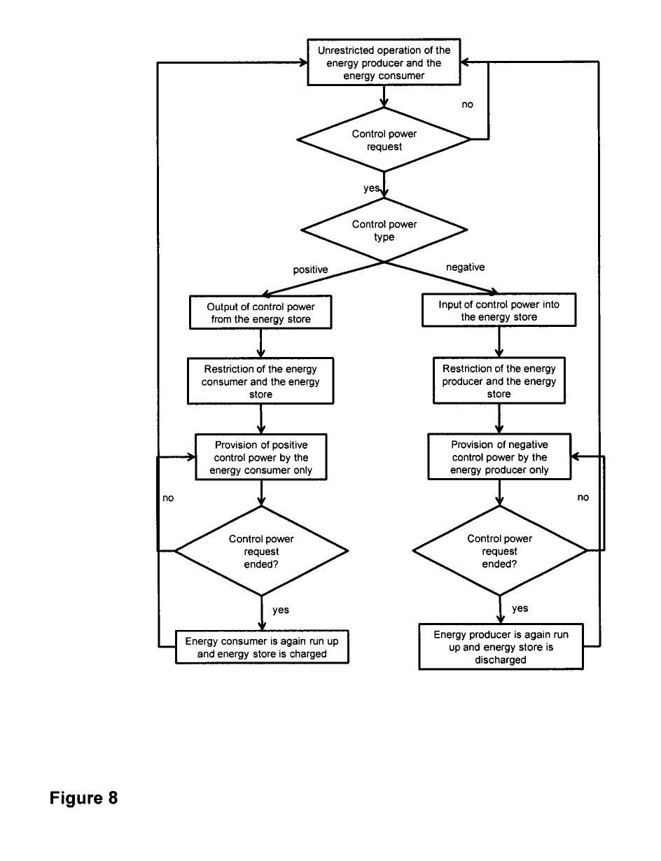

FIG. 8: shows a schematic flow diagram of an alternative embodiment of the method according to the invention incorporating an energy store.

FIG. 1 shows a schematic set-up of a device according to the invention for a method according to the invention comprising an energy producer 2 and an energy consumer 3 which are interconnected by means of a first electrical connection line 5. A second electrical connection line 6 sets up a connection between the energy producer 2, the energy consumer 3 and a central power supply network 1. Furthermore, the energy producer 2 is connected by means of a first communication connection 7 and the energy consumer 3 is connected by means of a second communication connection 8 to a control unit 4. A third communication connection 9 between the central power supply network 1 and the control unit 4 serves to transfer requests for required control power, both positive and negative.

It is intended to be made clear here that the energy producer 2 is interconnected with the energy consumer 3 by means of the first electrical connection line 5 in such a way that both the energy producer 2 and the energy consumer 3 are operated as far as possible under full load in the time periods in which no requirement exists for control power from the central power supply network 1. In this case, the energy producer 2 ideally supplies the energy required by the energy consumer 3 via the first electrical connection line 5 without the need for an energy removal from the central power supply network 1 by the energy consumer 3 or an energy feed into the central power supply network 1 by the energy producer 2 via the second electrical connection line 6.

Such an energy removal or energy feed into the central power supply network 1 occurs here only in the event of a control power requirement. However, it can also be provided that energy is fed into the power supply network 1 or is removed from the power supply network 1 also in normal operation without a control power requirement, without the method according to the invention being adversely effected hereby. To do this, both the energy producer 2 and the energy consumer 3 can also be connected directly and also separately to the power supply network 1.

As soon as a request for positive or negative control power is transferred by the power supply network operator to the control unit 4 or a control power requirement is established on the basis of a measurement of the frequency deviation of the network frequency, the control unit 4 then sends corresponding information via the first communication connection 7 to the control or regulation of the energy producer 2 (in the case of a request for negative control power) or via the second communication connection 8 to the control or regulation of the energy consumer 3 (in the case of a request for positive control power). The first and second electrical connection lines 5, 6 then serve to transfer energy between the central power supply network 1 and the energy producer 2 or the energy consumer 3.

In the case of a request for positive control power, the control unit 4 causes the energy consumer 3 to restrict its power by means of the second communication connection 8 in order to provide positive control power thereby which is then fed via the first and second electrical connection lines 5, 6 into the central power supply network 1. In this case, the energy producer 2 is unrestricted, ideally being further operated while maintaining full-load operation. As soon as the information is transferred from the central power supply network 1 by means of the third communication connection 9 to the control unit 4, or it is established on the basis of a measurement of the frequency deviation of the network frequency that the requirement for positive control power has been adequately fulfilled and consequently no further control power requirement exists, the control unit 4 causes the energy consumer 3 to run up its power once more by means of the second communication connection 8. Both the energy producer 2 and the energy consumer 3 are then further operated, once more unrestricted, ideally under full load, without a control power then being provided to the power supply network 1.

In the case of a request for negative control power or an established requirement for negative control power, the control unit 4 causes the energy producer 2 to restrict its power by means of the first communication connection 7 in order to provide negative control power thereby which is then removed from the central power supply network 1 via the first and second electrical connection lines 5, 6. The energy consumer 3 is in this case further operated in an unrestricted manner, ideally maintaining full-load operation. As soon as the information is transferred from the central power supply network 1 by means of the third communication connection 9 to the control unit 4, indicating that the requirement for negative control power has been adequately fulfilled and consequently no further control power requirement exists, the control unit 4 causes the energy producer 2 to run up its power once more by means of the first communication connection 7. Both the energy producer 2 and the energy consumer 3 are then further operated, once more unrestricted, ideally under full load, without a control power then being provided.

FIG. 2 shows a schematic set-up of a preferred embodiment of a device according to the invention which, similar to the device described in FIG. 1, comprises an energy producer 2′ and an energy consumer 3′ which are interconnected by means of a first electrical connection line 5′. A second electrical connection line 6′ sets up a connection between this first electrical connection line 5′ and a central power supply network 1′. Furthermore, the energy producer 2′ is connected by means of a first communication connection 7′ and the energy consumer 3′ is connected by means of a second communication connection 8′ to a control unit 4′. A third communication connection 9′ between the central power supply network 1′ and the control unit 4′ serves to transfer requests for both positive and negative control power.

Furthermore, the device according to the invention shown in FIG. 2, unlike the device according to the invention shown in FIG. 1, comprises an energy store 10 which is connected by means of a third electrical connection line 12 for the energy exchange with the central power supply network 1′, and also a fourth communication connection 11 between the energy store 10 and the control unit 4′. The control unit 4′ is therefore also used to control or regulate the energy store 10.

According to the invention, the energy store 10 can also be connected directly to the energy producer 2′ and to the energy consumer 3′. As a result, the energy store 10 can provide energy for the energy consumer 3′ and take in energy from the energy producer 2′. This is advantageous whenever a removal or delivery to the power supply network 1′ otherwise takes place without a control power request or the power increase of the energy producer 2′ and/or the energy consumer 3′ is to be increased per time, or an overshoot of the power of the energy producer 2′ and/or the energy consumer 3′ is to be prevented.

As soon as a request for positive or negative control power is transferred by the power supply network operator to the control unit 4′ or a corresponding requirement is established, the control unit 4′ then first transmits corresponding information by means of the fourth communication connection 12 to the energy store 10, since the latter, particularly in a preferred embodiment of the method according to the invention, can be used in a prioritized manner for the provision of positive and also negative control power. Control power is then transferred between the energy store 10 and the central power supply network 1′ by means of the third electrical connection line 12. Smaller fluctuations in the central power supply network 1′ and the resulting smaller control power requests can thus be quickly served by means of the energy store 10. As a result, more response time can be made available to the control unit 4′ in order to cause a restriction of the power of the energy consumer 3′ or the energy producer 2′ in the manner described in FIG. 1 by means of the first communication connection 7′ to control or regulate the energy producer 2′ (in the case of a request for negative control power) or by means of the second communication connection 8′ to control or regulate the energy consumer 3′ (in the case of a request for positive control power). The energy store is simultaneously restricted at the time of restriction of the energy consumer 3′ or the energy producer 2′. Here, to complement the process described in FIG. 1 following the fulfilment of the control power request from the central power supply network 1′, the power of the energy producer 2′ or the energy consumer 3′ can again be run up only after the energy store 10 has been given the opportunity to restore its original state of charge, ideally the half-charged state, once more by means of the energy exchange with the central power supply network 1′ via the third electrical connection line 12. However, the slope is also preferably used in the power run-up to adapt the state of charge. The energy producer 2′ or the energy consumer 3′ is particularly preferably run up again immediately, the energy is used during the run-up to optimize the state of charge of the energy store 10 and, if necessary, additionally to remove necessary energy for the charging of the energy store 10 from the power supply network 1′.

FIG. 3 shows a schematic power/time diagram for a positive control power request. Here, a first time 13 is the beginning of the restriction of the power 16 of an energy consumer, which is required in order to provide an adequate quantity of positive control power 17, whereas, according to the invention, the power 15 of an energy producer is maintained unrestrictedly constant. Here, the later second time 14 represents the end of the restriction of the energy consumer, wherein the power 16 then rises again to the original value and is then maintained constant. The power of the energy producer (upper line) can therefore be operated constantly at high (optimum) power.

FIG. 4 shows a schematic power/time diagram for a negative control power request. Here, the power 15′ of an energy producer is restricted at a first time 13′. An adequate quantity of negative control power 18 is thus made available by the system to the energy consumer and energy producer, while the power 16′ of the energy consumer is maintained unrestrictedly constant according to the invention. At the second later time 14′, the restriction of the energy producer is ended, wherein the power 15′ then rises once more to the original value and is then maintained constant.

Edges which are flatter than those shown in FIGS. 3 and 4 would in fact occur in the restriction and renewed run-up of the energy producer and energy consumer.

FIGS. 5A and 5B show two further schematic power/time diagrams. Here, Pₒₚₜ is the optimum power of the energy producers/consumers (optimum efficiency) and P_{dr} is the restricted power of the energy consumers/producers (poor efficiency).

FIG. 5A represents the case of a conventional control power provision according to the prior art. The energy producer or energy consumer (depending on whether positive or negative control power is provided here) runs in restricted mode (at P_{dr}) in order to provide positive or negative control energy or control power by temporarily increasing its power up to Pₒₚₜ.

The rated power P_{Nen} of the system (the prequalified power) is: P_{Nen}=Pₒₚₜ−P_{dr}

The shaded area is the energy which cannot be marketed or used by means of the selected operational management.

FIG. 5B represents the case of a control power provision according to the invention.

The energy producer (case 1) or energy consumer (case 2) runs with optimum efficiency (at Pₒₚₜ), and restricts its power only in order to provide negative (case 1) or positive (case 2) control energy or control power (up to P_{dr}). According to the invention, the reduction of the power of the energy producer causes a surplus of negative power by the energy consumer, as a result of which, in the aggregate, negative control energy is provided by the system to the energy consumer with the energy producer. According to the invention, the reduction of the power of the energy consumer causes a surplus of positive power by the energy producer, as a result of which, in the aggregate, positive control energy is supplied by the system to the energy consumer with the energy producer. If no control energy is required, both the energy consumer and the energy producer can therefore be operated at full power. The energy consumer then consumes the energy which the energy producer produces. In the aggregate, no control power is then provided to the power supply network.

The rated power of the system (prequalified power) is P_{Nen}=Pₒₚₜ−P_{dr}

The shaded area is the energy which cannot be marketed or used by means of the selected operational management.

FIGS. 5A and 5B provide the same control power, but the shaded areas are different, so that more power can be provided with a higher efficiency with the method according to the invention.

By means of the method according to the invention, both the energy producer and the energy consumer run more often with higher efficiency, which increases the productivity and economy of the systems.

FIG. 6 shows schematically the circuit for the control energy supply in the power supply network, wherein the control energy market/energy market transfers a corresponding request for positive or negative control power if required to the respective control-power-providing energy producers or consumers.

One or more batteries are combined here with a plurality of sources for positive and negative control power according to demand, wherein the negative control power provision originates exclusively from restrictable producers or from the battery or batteries. The latter must reduce their generation for the provision of the negative control power, and only then. Similarly, any required positive control power is provided exclusively from restrictable consumers or from the battery or batteries. The latter must correspondingly switch to partial load only in the case of the provision.

In the event of a control power request, an energy input or energy output by the energy store, i.e. the battery or batteries, is preferred. The energy producer and the energy consumer can then be operated even longer or for an even greater proportion of time at full power, i.e. with high efficiency.

Furthermore, the energy store can also be used for faster control power provision given that, due to the very fast control power provision from batteries, the edges in the event of a control power change are in fact as steep as those shown in the schematic diagrams according to FIGS. 3 and 4.

As a result, the associated losses due to the partial-load running mode known from the prior art can be significantly reduced if the combination of batteries and energy producers and consumers is effected in the manner shown in FIG. 6.

FIG. 7 describes a schematic flow diagram of a method according to the invention, wherein, at the beginning, both the energy producer and the energy consumer, which are jointly operated, are initially operated without the provision of control power in unrestricted form, ideally under full load.

In the first step of the method, it is queried whether a control power requirement of a network operator of a power supply network exists or the control power requirement is determined by measuring the frequency deviation of the network frequency. If no control power request exists, both the energy consumer and the energy producer are further operated unrestricted, as at the beginning. However, if a control power request of the network operator for the power supply network exists, the program sequence shown in FIG. 7 differs according to the requested control power type.

In the case of a positive control power request, the power of the energy consumer is restricted in order to then provide positive control power. The degree of power restriction of the energy consumer is dependent here on the quantity of requested positive control power. Positive control power continues to be provided by this method as long as a positive control power requirement by a network operator of a power supply network exists. Only after the control power requirement of the network operator has been fulfilled and accordingly no requirement for further provision of positive control power exists is the power of the energy consumer subsequently run up once more in order to then continue to operate it unrestricted, ideally under full load, as at the beginning of this circuit shown in FIG. 7.

In the case of a negative control power request, the power of the energy producer is restricted in order to then provide negative control power. The degree of the power restriction of the energy producer is dependent on the quantity of requested negative control power. Negative control power continues to be provided by this method as long as a negative control power requirement by the network operator of the power supply network exists. Only after the control power requirement of the network operator has been fulfilled and accordingly no requirement for further provision of negative control power exists is the power of the energy producer subsequently run up once more in order to then continue to operate it unrestricted, ideally under full load, as at the beginning of this circuit shown in FIG. 7.

FIG. 8 describes a schematic flow diagram of a preferred embodiment of the method according to the invention incorporating an energy store. In the case of the program sequence shown in FIG. 8 with a control power request, the program sequence as described in FIG. 7 is preceded by an additional downstream prioritized incorporation of an energy store.

Here, control power is initially provided from or taken in by said energy store in the case of a control power request of a network operator of a power supply network, depending on whether said control power is positive or negative. The capacity of the energy store does not have to be selected as so large that the energy store is provided or suffices as the sole control power supplier in order to fulfil the control power requirement on its own, since the energy producer or energy store will come into play at some point. The energy store is therefore intended in particular to meet brief short-time requirements. A combination of an energy store of this type with a restriction of an energy producer or energy consumer is included according to the invention, wherein a distinction is to be made here depending on the—positive or negative—control power request type.

In the case of a positive control power request, after the energy store has already provided control power by discharging the energy store, the power of the energy consumer and, in parallel thereto, the power of the energy store are simultaneously restricted in order to subsequently provide further positive control power by means of said restricted energy consumer only. The degree of the power restriction of the energy consumer may also theoretically be dependent on the amount of the requested positive control power. In the case of primary control power, the control power is set in proportional dependence on the frequency deviation of the network frequency.

As long as a positive control power requirement by a network operator of a power supply network exists or such a requirement is established by the frequency deviation, positive control power continues to be provided by this method. Only if a requirement for further provision of positive control power no longer exists is the power of the energy consumer again run up and the energy store is simultaneously recharged, wherein the energy store is not fully charged here, but preferably to 50%, in order to be able to use it as efficiently as possible in the event of a future control power request for the provision of both positive and negative control power. The energy consumer is then further operated once more unrestricted, ideally under full load, as at the beginning of the circuit shown in FIG. 8.

In the case of a negative control power request, after the energy store has already provided control power by taking in energy into the energy store, the power of the energy producer and the power of the energy consumer are simultaneously restricted in order to continue to provide constant negative control power (rated power) in the aggregate by both and then by the restricted energy producer only. The degree of the power restriction of the energy producer is dependent here on the quantity of requested negative control power.

As long as a negative control power requirement by a network operator of a power supply network exists, negative control power continues to be provided by this method. Only if a requirement for further provision of negative control power no longer exists is the power of the energy producer again run up and the energy store is simultaneously discharged once more, wherein the energy store is not fully discharged here, but preferably to around 50%, in order to be able to use it as efficiently as possible in the event of a future control power request for the provision of both positive and negative control power. The energy producer is then further operated once more unrestricted, ideally under full load, as at the beginning of the circuit shown in FIG. 8.

The method according to the invention thus enables a provision of control power for a power supply network without being affected by the disadvantages of the existing prior art.

This method according to the invention for the provision of control power for a power supply network in which control power is provided is defined by the characterizing features of the attached claims.

The features of the invention disclosed in the preceding description and in the claims, figures and example embodiments can be essential both individually and in any combination for the realization of the invention in its different embodiments.

### REFERENCE NUMBER LIST

1, 1′ Central power supply network

2, 2′ Energy producer

3, 3′ Energy consumer

4, 4′ Control unit

5, 5′ First electrical connection line

6, 6′ Second electrical connection line

7, 7′ First communication connection

8, 8′ Second communication connection

9, 9′ Third communication connection

10 Energy store

11 Third electrical connection line

12 Fourth communication connection

13, 13′ First time

14, 14′ Second time

15, 15′ Power characteristic of the energy producer

16, 16′ Power characteristic of the energy consumer

17 Positive control energy

18 Negative control energy

1-12. (canceled)

13. A method for a provision of control power for a power supply network in which control power is provided,
wherein an energy producer and an energy consumer are jointly operated,
wherein power which the energy consumer removes from the power supply network is restricted to provide a positive control power, and power which the energy producer feeds into the power supply network is restricted to provide a negative control power.

14. A method according to claim 13, wherein
the energy producer and the energy consumer are operated with a relative efficiency in relation to respective theoretical maximum efficiency of the energy producer or energy consumer of at least 70%, or at least 80%, or at least 90%, or at least 95%, if no control power is provided.

15. A method according to claim 13, wherein
a power station, a coal-fired power station, a gas-fired power station or a hydroelectric power station is used as an energy producer, and/or an industrial production plant, an electrolysis plant or an industrial production plant for provision of a metal, aluminium or steel, is used as an energy consumer.

16. A method according to claim 13, wherein,
in a provision of positive control power, the energy producer is operated with an efficiency in relation to respective theoretical maximum efficiency of the energy producer of at least 70%, or at least 80%, or at least 90%, or at least 95%, and/or, in a provision of negative control power, the energy consumer is operated with an efficiency in relation to respective theoretical maximum efficiency of the energy consumer of at least 70%, or at least 80%, or at least 90%, or at least 95%.

17. A method according to claim 13, wherein
an energy store, a battery, a Li-ion battery, or a pooling of energy stores is operated jointly with the energy producer and the energy consumer, and the energy store or energy stores, or the battery, is operated such that it is given priority over the energy consumer and the energy producer in a provision of positive and/or negative control power, wherein the energy store, or the battery, has a capacity of at least 4 kWh, or at least 10 kWh, or at least 50 kWh, or at least 250 kWh.

18. A method according to claim 17, wherein
the energy store is used to prevent overshoots of a rated power and/or to accelerate a change with time in the power in an event of a change in the control power to be provided.

19. A method according to claim 13, wherein
a prequalified power of the energy producer corresponds to a prequalified power of the energy consumer.

20. A method according to claim 13, wherein
the energy producer is operated under full load except in a provision of negative control power and/or the energy consumer is operated under full load except in a provision of positive control power.

21. A method according to claim 13, wherein
power of the energy producer deliverable to the power supply network and/or power of the energy consumer removable from the power supply network can be changed within 15 minutes, or within 5 minutes, or within 30 seconds, by at least 70%, or at least 85%, or at least 95%, together with a battery.

22. A device to carry out a method according to claim 13, comprising
at least one energy producer, at least one energy consumer, and a control to control or regulate the power of the energy producers and energy consumers, wherein the energy producers and energy consumers are connected to a power supply network such that energy can be fed into the power supply network and can be removed from the power supply network by means of the device.

23. A device according to claim 22, wherein
the control is configured so that the energy producer and/or the energy consumer are operable at any time with a high efficiency in relation to respective theoretical maximum efficiency of the energy producer or energy consumer, or at least 70%, or at least 80%, or at least 90%, or at least 95%.

24. A device according to claim 22, further comprising an energy store, or a battery, which is connected to the power supply network such that energy can be fed from the energy store, or from the battery, into the power supply network, and can be removed from the power supply network.
